(19) United States
(12) Patent Application Publication
(10) Pub. No.: US 2022/0004595 A1
(43) Pub. Date: Jan. 6, 2022

(54) DEVICE FOR CALCULATING AN ANALOG FOURIER TRANSFORM

(71) Applicant: THALES, COURBEVOIE (FR)

(72) Inventors: Patrick GARREC, MERIGNAC (FR); Jean-Michel HODE, MERIGNAC (FR); Victor VAILLANT, MERIGNAC (FR)

(21) Appl. No.: 17/291,258

(22) PCT Filed: Nov. 8, 2019
(86) PCT No.: PCT/EP2019/080745

§ 371 Date: May 4, 2021

(51) Int. Cl. G06F 17/14; H03M 1/12

(52) U.S. Cl. CPC G06F 17/142; H03M 1/1205

(57) ABSTRACT

The device transforms an analog input signal with N components x(0), x(1) . . . x(N−1) into an output signal with N components X(0), X(1) . . . X(N−1) functions of said components x(0), x(1) . . . x(N−1), said device comprising basic addition and/or subtraction cells linked in a butterfly-type architecture to perform said functions, each basic cell comprising an operator performing a conditional division by two of the result of the addition operation or subtraction operation performed, the condition being the saturation of said operator.

The present invention relates to a device for computing an analog Fourier transform. The invention is especially applicable to the fields of radar, of countermeasures and of active decoys, and more particularly to signal processing with a view to improving the dynamic range of received signals, and especially with a view to responding to jamming in very short times while remaining compatible with the dynamic ranges of the signals to be processed.

When signal analysis time becomes critical with regard to reaction time, analog processing preserves an advantage with respect to digital processing. The performance of analog signal processing is however dependent on processing dynamic range, which is limited, in contrast to digital processing. In particular, the achievable dynamic range, including the gain associated with the filters of the Fourier transform, is a problem when analog Fourier transforms are used. Specifically, it is necessary to be able to process signals the level of which is below the noise threshold and to extract these signals in order to process them.

In the context of the invention, the prior art relates to DRFM (“Digital Radio Frequency Memories”) which allow responses to the threat to be created. The methods of dilution, seduction, confusion and deception require rapid analyses, which are carried out with restricted dynamic ranges. It is not uncommon to have memories of 1 bit depth, this being insufficient, especially in the presence of multiple sources of interference, whether intentional or not.

To deal with multiple threats, or to be able to respond in the presence of communication signals, higher dynamic range is required.

Current analog methods for processing Fourier transforms ensure that dynamic-range overflow does not occur.

Therefore, whenever the processing of the signal is able to generate processing gain, a normalization is performed. These methods have the advantage of controlling the dynamic range of the output signals insofar as there is no possibility of saturation if the input does not saturate. One drawback, however, is SCV (“Sub Clutter Visibility”). Specifically, by dividing the signals by the maximum possible gain, the noise factor is degraded and it is no longer possible to extract signals buried in the noise. Very many architectures implementing the known Doppler-butterfly method use this technique. The following documents illustrate this:
F. Rivet, “Contribution à l'étude et à la réalisation d'un frontal radiofréquence analogique en temps discret pour la radio-logicielle intégrale”, 2009;
B. Sadhu R. Harjani, “Cognitive Radio Receiver Front-Ends”, Chapter 5 CRAFT: Charge Re-use Analog Fourier Transform, 2014;
A. A. Balakrishnan V. Suresh Babu M. R. Baiju, “Implementation of Radix-2 and Split-Radix Fast Fourier Transform Algorithm Using Current Mirrors”, 2013.

One aim of the invention is to overcome the drawbacks of the prior art, especially by making it possible to increase the performance of detection of signals buried in noise, while keeping the guarantee that saturation will not affect the processing of the signal. To this end, one subject of the invention is a device for computing an analog Fourier transform, converting an analog input signal with N components x(0), x(1) . . . x(N−1) into an output signal with N components X(0), X(1) . . . X(N−1) that are functions dependent on said components x(0), x(1) . . . x(N−1), said device comprising elementary analog addition and/or subtraction cells that are connected in a butterfly architecture to achieve said functions, each elementary cell being able to perform a conditional division by two of the result of the addition or subtraction operation performed, the condition being the saturation of an addition and/or subtraction operation.

In one possible embodiment, the butterfly architecture being of the parallel type, each elementary cell, which receives two signals (A, B) as input, comprises at least:
an analog adder:
   that performs the addition of said signals (A+B) and delivers the result to a first output;
   that performs said addition divided by two ((A+B)/2) and delivers the result to a second output;
   that is equipped with a comparator able to detect a saturation of said operator, and that delivers the saturation datum to a third output;
a first module that selects one or other of said outputs of said adder depending on said saturation datum, the selected output forming the first output of said elementary cell;
an analog subtractor:
   that performs the subtraction between said signals (A−B) and delivers the result to a first output;
   that performs said subtraction divided by two ((A−B)/2) and delivers the result to a second output;
a second module that selects one or other of said outputs of said subtractor depending on said saturation datum, the selected output forming the second output of said elementary cell.

Said elementary cells being grouped in rows and in stages, said modules of a given stage are for example controlled by the same signal, said signal commanding the division by two as soon as at least one cell delivers a saturation datum.

In another possible embodiment, the butterfly architecture being of the series type, each elementary cell, which receives two signals A, B as input, comprises at least:
an analog adder:
   that performs a first addition A+B and delivers the result to a first output;
   that performs said first addition divided by two ((A+B)/2) and delivers the result to a second output;
   that performs a second addition A/2^{k}+B and delivers the result to a third output, k being the rank of the stage to which said cell belongs in said series architecture;
   that performs said second addition divided by two ((A/2^{k}+B)/2) and delivers the result to a fourth output;
   that is equipped with a comparator able to detect a saturation of said adder;
a memory that receives said saturation datum and the saturation data from the operators of the previous stages, said module delivering a command datum depending on said saturation data;
a first multiplexer that has as inputs said outputs of said adder, said multiplexer selecting as output one of said inputs depending on said command datum, the selected output forming the first output of said elementary cell;
an analog subtractor:
   that performs a first subtraction A−B and delivers the result to a first output;
   that performs said first subtraction divided by two ((A−B)/2) and delivers the result to a second output;
   that performs a second subtraction A/2^{k}−B and delivers the result to a third output;
   that performs said second subtraction divided by two ((A/2^{k}−B)/2) and delivers the result to a fourth output;
a second multiplexer that has as inputs said outputs of said subtractor, said multiplexer selecting as output one of said inputs depending on said command datum, the selected output forming the second output of said elementary cell.

Said memory for example comprises a state machine that delivers said command data.

Other features and advantages of the invention will become apparent with reference to the appended drawings, which show:

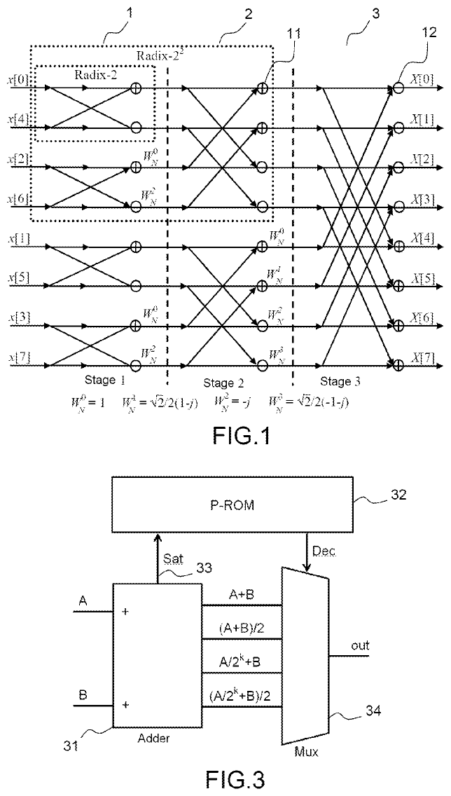

FIG. 1, an example of an algorithm for computing a butterfly FFT;

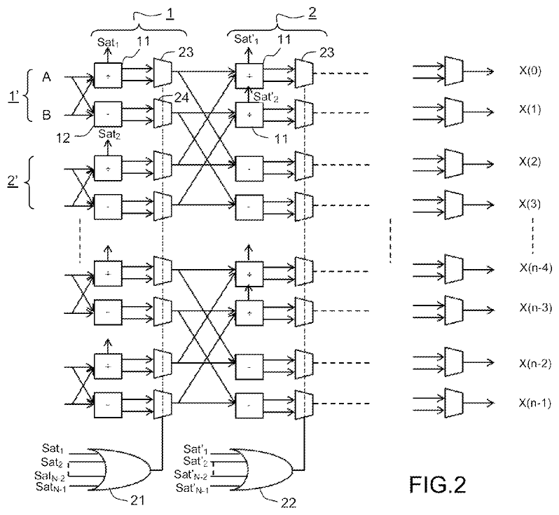

FIG. 2, a first exemplary embodiment of a device according to the invention in an architecture of parallel type;

FIG. 3, an exemplary embodiment of a conditional adder used in a device according to the invention, in an architecture of series type;

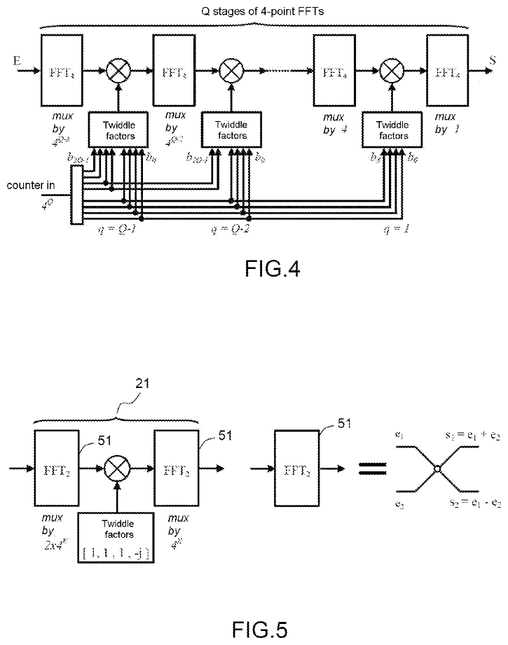

FIG. 4, an architecture for computing a Radix-4 FFT;

FIG. 5, a breakdown of a 4-point FFT into two two-point FFTs;

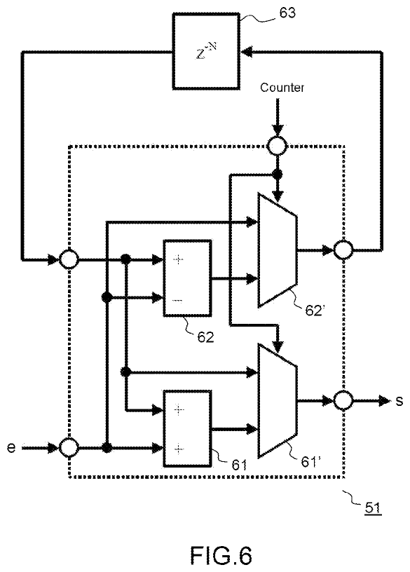

FIG. 6, an elementary cell for computing a two-point FFT using a conditional adder of the type shown in FIG. 3;

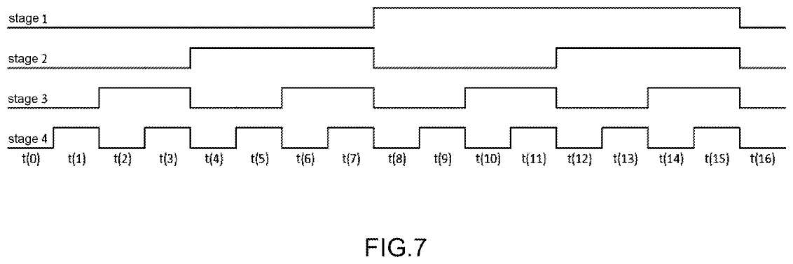

FIG. 7, a timing diagram of counters used in a device according to the invention, in an architecture of series type;

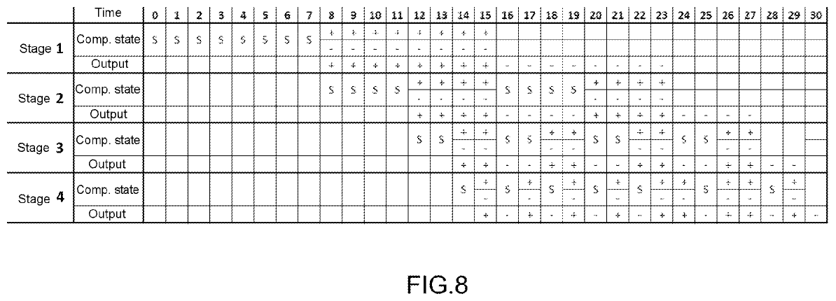

FIG. 8, an illustration of an example of a program of a state machine controlling the stages of a device according to the invention in a series architecture.

The present invention advantageously makes it possible to improve the dynamic range of an electronic system for performing a discrete fast-Fourier transform (FFT). For the clarity of the description, examples of charge-transfer architectures based on known Cooley-Tukey algorithms based on Radix-2, and in particular on Radix-2 and Radix-4 algorithms, will be presented. The principle of the invention can be extended to other types of implementation of the FFT.

Before describing the invention, the definition of radiofrequency dynamic range and the specificities of the FFT will be recalled.

In radiofrequency analysis, the dynamic range D of a system may commonly be defined as the difference between the maximum input power P_{in,max} and the minimum input power P_{in,min} that the system can handle, i.e.

D=P_{in,max}−P_{in,min} (1)

The minimum input power P_{in,min} is the input power from which the system delivers what may be called an exploitable output signal S, i.e. an output signal-to-noise ratio SNR_{out,min} sufficient to exceed the background noise F:

S=F+SNR_{out,min} (2)

The background noise is defined as the sum of the thermal noise Pₜₕ and of the noise factor NF of the system, namely:

S=Pₜₕ+NF+SNR_{out,min} (3)

The maximum input power may be defined as the power from which distortions appear in the output of the system. In practice, intermodulation products of order three may be considered.

The discrete fast-Fourier transform (FFT) is a projection of the studied signal into a basis made up of sinusoidal functions. The transform may also be seen as a bank of filters in which each filter is matched to one of the vectors of the projection basis, i.e. to one of the sinusoids. It is therefore a set of matched filters for which a coherent gain may be computed. The presence of such a gain means that the FFT is able to discriminate between periodic signals and non-periodic signals (here, the noise). It performs a coherent integration of the useful signal.

It may be shown that a noisy signal processed by an FFT may potentially be extracted from the noise in which it is buried. An FFT, just like a bank of matched filters, is able to process periodic signals over a dynamic range which is not limited by the noise floor, this also being referred to as SCV (“Sub Clutter Visibility”), which was mentioned in the introduction.

An FFT is therefore able to contribute to this SCV. Specifically, the signal remains “visible” even below a certain noise threshold since the coherent FFT gain is added to coherent signals (frequencies correlated by the FFT) without amplifying the noise.

However, in an analog electronic architecture, the dynamic range of a signal is limited by the power source in particular. If the latter delivers a voltage VDD of 1 volt for example, no signal will be able to exceed 1 volt. This means, in the case of propagated additions, that saturation is possible, decreasing the veracity of the transmitted datum. A conventional solution consists in systematically dividing by 2 operands during addition. The property of SCV is then lost in the noise accumulated during the divisions.

In order to take maximum advantage of the property of SCV, the invention integrates a conditional division into the architecture of the FFT, as will be described below. The division is applied to all of the N samples if and only if saturation occurs. The saturation of an operator performing an addition or subtraction operation corresponds to the overflow of the dynamic range of this operator.

FIG. 1 illustrates a known computation algorithm, used to optimize the computation of an 8-point FFT in this example. This algorithm is commonly referred to as a butterfly. The passage from one computation stage (“Radix 2”) to the next is achieved via addition or subtraction. Multiplications are performed on intermediate data, throughout the FFT computation algorithm. The formula of the applied multiplier coefficients is known. These coefficients W_{N}⁰, W_{N}¹, W_{N}², W_{N}³ are trigonometric constants lower than 1. They are known as twiddle factors.

In this “butterfly” algorithm, the additions and subtractions generate increases in dynamic range. In the example of FIG. 1, in the case of an 8-point FFT, the total gain is 6 dB for the three successive operations, corresponding to the three stages 1, 2, 3 of the algorithm. The additions and subtractions are carried out by elementary addition operators 11 and elementary subtraction operators 12 of analog type, i.e. carried out according to a known analog structure, respectively. In the rest of the description, all the addition operators and all the subtraction operators are of analog type.

Conventionally in analog FFTs, to avoid any risk of saturation, in each operation there is a division by two. This method is a very effective way of avoiding saturations, but it is detrimental to the noise factor, which is degraded by this division.

Reference is made to FIG. 2 which illustrates the implementation of the invention for an architecture of parallel type. More particularly, FIG. 2 shows the same architecture as FIG. 1 but in a configuration according to the invention, the twiddle factors not being shown.

For the implementation of the FFT, the elementary cells that carry out the addition and/or subtraction operations are connected to form a butterfly structure. In the parallel configuration of FIG. 2, the connected elementary cells are arranged in parallel (in rows 1′, 2′) and cells of same rank among these connected cells are grouped in stages. Two stages 1, 2 are shown in FIG. 2.

According to the invention, a division by two is carried out if an overflow occurs; thus the ability to extract a signal buried in noise is preserved. In other words, to avoid the compromise between noise factor and saturation, the invention proposes to carry out a conditional division by two.

Each elementary operator (adder or subtractor) must then be able to deliver two possible outputs:
the operation (addition or subtraction);
the operation divided by two.

Written differently, if A and B are the analog input signals, each operator performs:
A±B and (A±B)/2

Depending on the saturation, A±B or (A±B)/2 is selected.

Saturation may result from addition as well as from subtraction. Each operator is provided internally with a comparator able to detect this saturation.

An operator thus comprises a third output Sat₁, Sat₂, Sat′₁, Sat′₂ indicating the saturation state, in the form of a binary datum.

Each stage is equipped with a gate 21, 22. For each stage, this gate applies the OR logic function to all of its inputs, the latter being the saturation states supplied by all of the elementary operators 11, 12 of the stage. The OR gate selects, via a multiplexer 23, 24, the appropriate output for all the elementary operators:
the addition or subtraction operation, A±B;
or the division by two, (A±B)/2.

FIG. 3 illustrates implementation for the case of a series architecture, and more precisely illustrates what happens in one elementary operator.

In the case of a series architecture, the saturations are processed in a different way. Specifically, the samples of the FFT being pipelined, it is possible, for example, to be confronted with the case of a saturation in a stage N (N^{th} stage) on the k^{th} operation (k>1). Although it is possible to start the operations divided by two from this k^{th} operation, this also means that the previous k−1 operations will have passed through stage N without being divided by two. It is then necessary to envisage a propagation of the division to the following stages N+n in order to keep the same scale ratio for all the processed samples. To this end, the invention makes provision for four outputs from the elementary operators.

FIG. 3 shows one example of implementation. The operator 31 shown is an adder that in fact performs the following operations:
A+B (output 1);
(A+B)/2 (output 2);
A/2^{k}+B (output 3);
(A/2^{k}+B)/2 (output 4).

The results of these four operations are delivered via the four outputs of the operator. A multiplexer 34 selects one or other of these outputs depending on a command Dec. The adder is also provided with an internal comparator for detecting saturations.

The first output delivers the present addition A+B; it is selected by the multiplexer if no saturation is detected.

The second output delivers the present addition divided by two, (A+B)/2. It is selected if the present addition saturates.

The third output delivers A/2^{k}+B. It is selected when a saturation has occurred in the previous stage after unsaturated additions have been transmitted to this stage. It is therefore necessary to compensate for these unsaturated additions to keep the same scale with the future additions that will be divided by two.

The fourth output delivers (A/2^{k}+B)/2. It is selected if the previous case occurs at the same time as a saturation also occurs in this stage, hence the division by 2.

In addition to these outputs, there is an output 33 that delivers a datum “Sat” that provides information on the saturation state of the operator. This output 33 is delivered to a memory 32 which, based on the saturation state of each operator for each stage, generates an output decision. This output decision is the command Dec described above that selects, via the multiplexer 34, one of the outputs described above. The memory 32 therefore comprises a program (state machine) that allows the appropriate command datum to be delivered depending on the saturation datum of the current operator and on the saturation datum of the operators of the previous stages. The command datum Dec may be coded on 2 bits with a view to selecting one of the four inputs of the multiplexer. The memory 32 forms a control module taking the form of a state machine.

FIG. 3 shows an adder; on the same principle, a subtractor may be provided that performs:
A−B (output 1);
(A−B)/2 (output 2);
A/2^{k}−B (output 3);
(A/2^{k}−B)/2 (output 4).

This memory 32 will now be described in the context of an example of a 16-point FFT having the series architecture illustrated in FIG. 4, which series architecture employs the invention. Compared to a conventional series implementation, the multiplexing decreases from stage to stage. FIG. 4 illustrates the general case with Q FFT₄ (4-point FFT) stages, and Q−1 series of twiddle factors, q ranging from Q−1 to 1.

It will be noted that an FFT₄ block may be broken down simply into two FFT₂ blocks, as illustrated in FIG. 5.

Radix-4 stages may therefore be broken down into Radix-2 stages. For 16 points, this means that there are 4 Radix-2 stages, and hence eight operators that may saturate. FIG. 5 illustrates this breakdown in that it shows elementary blocks 51 (FFT₂) that are Radix-2 rather than Radix-4 blocks, with the elementary operations e₁+e₂ and e₁−e₂. An FFT₂ block thus performs the most elementary operations of the algorithm, the addition (e₁+e₂) and the subtraction (e₁−e₂). This elementary block of the architecture is described with reference to FIG. 6 below.

FIG. 6 therefore illustrates an elementary Radix-2 block 51 (FFT₂). In the context of the invention, the operators 61, 62 are of the type shown in FIG. 3. The addition operator 61 performs the operations described with reference to FIG. 3.

The second operator 62 is a subtraction operator that operates on the same principle as the addition operator 61 described above.

A first multiplexer 61′ selects the output of the adder 61 or the output of a second multiplexer 62′ via a delay line 63 specific to the technology used and depending on the stage. The second multiplexer 62′ selects the output of the subtractor 62 or the input e of the elementary block. The adder 61 adds this input e and the output of the delay line. The subtractor 62 subtracts the input e from the output of the delay line.

The multiplexers select either of their inputs depending on a logic state delivered by a counter the timing diagram of which is shown in FIG. 7 for each of the stages, with respect to successive time periods t(1), t(2) . . . t(16). For the clarity of the description, an N=4²=16 point Fourier transform will therefore be considered. An architecture with two pipelined blocks is obtained, i.e. 4 FFT₂ blocks of the type shown in FIG. 6, which are called stage 1, stage 2, stage 3 and stage 4. The results of the elementary operations are thus produced in series at the rates of the counters specific to each stage.

Reference is now made again to FIG. 3, which illustrates an elementary adder 61 such as shown in FIG. 6. The principle of operation is the same for a subtractor. The selection of channels:
A+B;
(A+B)/2;
A/2^{k}+B;
(A/2^{k}+B)/2.
   is dependent on the decoding datum Dec (coded on two bits). Said datum is delivered by the memory 32 and controls the multiplexer 34 or any other selecting means used. To deliver these commands dependent on saturation state Sat, the memory 32 comprises a state machine.

FIG. 8 illustrates the operations carried out in each stage as well as their pipelined outputs, in the context of the preceding example with 4 FFT₂ stages for a 16-point FFT. Using this timing-diagram table, an example of programming of a state machine in the memory 32, with a view to managing the outputs of each adder, will be described. This example is given for the particular case of a 16-point transform for the clarity of the explanation, the generalization by recurrence to a higher-order transform being straightforward.

The description of the state machine described below may be read in the light of FIG. 8. For each stage, the computation state and the output are given as a function of time. Each column describes the state for a time period t, this time period corresponding to one time period of the timing diagram of FIG. 7 (successive time periods t(1), t(2), etc.). The table shows a sequence of 30 time periods.

“S” represents the storage state during which the delay line 63 of an elementary block FFT₂ fills. In the case of N=16, its depth is, from stage to stage, 8, 4, 2 and 1.

Below, Satₖ represents a saturation that has appeared in stage k.

The selected states are (for the adder or subtractor outputs described previously):
State A: output 1;
State B: output 2;
State C: output 3;
State D: output 3 alternating with output 1 (see timing diagrams below);
State E: output 4;
State F: output 4 alternating with output 2 (see timing diagrams below).

Regarding the memory 32:
It is here divided into 4: one state machine per stage;
It locks the signals Satₖ: i.e. it holds the datum until the entire FFT operation has ended;

State Machine of Stage 1:

State A: If not Sat₁.

State B: If Sat₁, until t=16.

Note that in stage 1 the adder and subtractor do not need outputs 3 and 4.

State Machine of Stage 2:

State A: If not (Sat₁+Sat₂).

State B: If Sat₂, until t=24.

State C: If (Sat₁·(t>=12)), until t=24.

State D: If (Sat₁·(t(8)<t(12−i)<t(12))). The table below shows the timing diagram of the outputs of stage 2 in state D:

| | | | | | | | | |
|---|---|---|---|---|---|---|---|---|
| t(12) | . . . | t(16-i) | . . . | t(16) | . . . | t(24-i) | . . . | t(24) |

| | | | | | | | |
|---|---|---|---|---|---|---|---|
| output 3 | output 3 | output 1 | output 1 | output 3 | output 3 | output 1 | output 1 |

State E: If ((Sat₂·Sat₁)·(t>=12)), until t=24.

State F: If ((Sat₂·Sat₁)·(t8)<t(12−i)<t(12))): see the same timing diagram as previously with output 4 and output 2 instead of output 3 and output 1.

State Machine of Stage 3:

State A: If not (Sat₁+Sat₂+Sat₃).

State B: If Sat₃, until t=28.

State C: If ((Sat₁+Sat₂)·(t>=14)), until t=28.

State D: If ((Sat₁+Sat₂)·(t(12)<t(14−i)<t(14))):

| | | | | | | | | | | | | | | | | |
|---|---|---|---|---|---|---|---|---|---|---|---|---|---|---|---|---|
| t(14) | . . . | t(16-i) | . . . | t(16) | . . . | t(20-i) | . . . | t(20) | . . . | t(24-i) | . . . | t(24) | . . . | t(28-i) | . . . | t(28) |

| | | | | | | | | | | | | | | | |
|---|---|---|---|---|---|---|---|---|---|---|---|---|---|---|---|
| out- | out- | out- | out- | out- | out- | out- | out- | out- | out- | out- | out- | out- | out- | out- | out- |
| put 3 | put 3 | put 1 | put 1 | put 3 | put 3 | put 1 | put 1 | put 3 | put 3 | put 1 | put 1 | put 3 | put 3 | put 1 | put 1 |

State E: If ((Sat₃·(Sat₁+Sat₂))·(t>=12)), until t=28.

State F: If ((Sat₃·(Sat₁+Sat₂))·(t(12)<t(14−i)<t(14))): see the same timing diagram as before with output 4 and output 2 instead output 3 and output 1.

State Machine of Stage 4:

State A: If not (Sat₁+Sat₂+Sat₃+Sat₄).

State B: If Sat₄, until t=30.

State C: If ((Sat₁+Sat₂+Sat₃)·(t>=15)), up to t=30.

State D: This stage being multiplexed by 1, this state does not exist.

State E: If ((Sat₄·(Sat₁+Sat₂+Sat₃))·(t>=15)), until t=30.

State F: This stage being multiplexed by 1, this state does not exist.

Note that the output is divided by two if Sat₄ for (t>15)).

The state machine of the memory 32 may be programmed in other ways. The latter memory is for example a programmable memory P-ROM.

1. A device for computing an analog Fourier transform, converting an analog input signal with N components x(0), x(1) . . . x(N−1) into an output signal with N components X(0), X(1) . . . X(N−1) that are functions dependent on said components x(0), x(1) . . . x(N−1), said device comprising elementary analog addition and/or subtraction cells that are connected in a butterfly architecture to achieve said functions, characterized in that each elementary cell is able to perform a conditional division by two of the result of the addition or subtraction operation performed, the condition being the saturation of an addition and/or subtraction operation.

2. The device as claimed in claim 1, characterized in that the butterfly architecture being of the parallel type, each elementary cell, which receives two signals (A, B) as input, comprises at least:
an analog adder:
that performs the addition of said signals (A+B) and delivers the result to a first output;
that performs said addition divided by two ((A+B)/2) and delivers the result to a second output;
that is equipped with a comparator able to detect a saturation of said operator, and that delivers the saturation datum to a third output;
a first module that selects one or other of said outputs of said adder depending on said saturation datum, the selected output forming the first output of said elementary cell;
an analog subtractor:
that performs the subtraction between said signals (A−B) and delivers the result to a first output;
that performs said subtraction divided by two ((A−B)/2) and delivers the result to a second output;
a second module that selects one or other of said outputs of said subtractor depending on said saturation datum, the selected output forming the second output of said elementary cell.

3. The device as claimed in claim 2, characterized in that said elementary cells being grouped in rows and in stages, said modules of a given stage are controlled by the same signal, said signal commanding the division by two as soon as at least one cell delivers a saturation datum.

4. The device as claimed in claim 1, characterized in that the butterfly architecture being of the series type, each elementary cell, which receives two signals (A, B) as input, comprises at least:
an analog adder:
that performs a first addition A+B and delivers the result on a first output;
that performs said first addition divided by two ((A+B)/2) and delivers the result to a second output;
that performs a second addition A/2^{k}+B and delivers the result to a third output, k being the rank of the stage to which said cell belongs in said series architecture;
that performs said second addition divided by two ((A/2^{k}+B)/2) and delivers the result to a fourth output;
that is equipped with a comparator able to detect a saturation of said adder;
a memory that receives said saturation datum and the saturation data from the operators of the previous stages, said module delivering a command datum depending on said saturation data;
a first multiplexer that has as inputs said outputs of said adder, said multiplexer selecting as output one of said inputs depending on said command datum, the selected output forming the first output of said elementary cell;
an analog subtractor:
that performs a first subtraction A−B and delivers the result to a first output;
that performs said first subtraction divided by two ((A−B)/2) and delivers the result to a second output;
that performs a second subtraction A/2^{k}−B and delivers the result to a third output;
that performs said second subtraction divided by two ((A/2^{k}−B)/2) and delivers the result to a fourth output;
a second multiplexer that has as inputs said outputs of said subtractor, said multiplexer selecting as output one of said inputs depending on said command datum, the selected output forming the second output of said elementary cell.

5. The device as claimed in claim 4, characterized in that said memory comprises a state machine that delivers said command data.
